(19) United States
(12) Patent Application Publication
(10) Pub. No.: US 2011/0101964 A1
(43) Pub. Date: May 5, 2011

(54) Magnetic Encoder Element for Position Measurement

(76) Inventors: Udo Ausserlechner, Villach (AT); Tobias Werth, Villach (AT); Peter Slama, Klagenfurt (AT); Juergen Zimmer, Neubiberg (DE); Wolfgang Raberg, Sauerlach (DE); Stephan Schmitt, Munich (DE); Martin Orasch, Villach (AT)

(21) Appl. No.: 12/613,376

(22) Filed: Nov. 5, 2009

(51) Int. Cl. G01B 7/30

(52) U.S. Cl. 324/207.11

(57) ABSTRACT

A magnetic encoder element for use in a position measurement system including a magnetic field sensor for measuring position along a first direction is disclosed. The encoder element includes at least one first track that includes a material providing a magnetic pattern along the first direction, the magnetic pattern being formed by a remanent magnetization vector that has a variable magnitude dependent on a position along the first direction. The gradient of the remanent magnetization vector is such that a resulting magnetic field in a corridor above the first track and at a predefined distance above the plane includes a field component perpendicular to the first direction that does not change its sign along the first direction.

### TECHNICAL FIELD

The present invention relates to magnetic encoder elements for use in a position measurement system including magnetic field sensors, particularly magnetic encoder wheels for use in systems for measuring angular position or rotational speed.

### BACKGROUND

In order to detect the angular position, speed, or acceleration of a shaft it is known to attach a magnetic encoder wheel to the shaft and a magnetic field sensor nearby. The magnetic encoder wheel has a plurality (usually 60) of alternately magnetized permanent magnets arranged side by side along its circumference thus generating a magnetic pattern of alternating magnetization. The sensor detects the changes in magnetic field, when the encoder wheel rotates thus detecting the movement of the shaft.

Common sensors are Hall effect sensors and magneto-resistive sensors. In recent time XMR-sensors are used whereby XMR stands for any of the following: AMR (anisotropic magneto-resistive), GMR (giant magneto-resistive), TMR (tunneling magneto-resistive), CMR (colossal magneto-resistive) or the like.

The common feature of these XMR sensors is that they have a thin ferromagnetic layer, wherein the magnetization can rotate freely. The direction, in which the magnetization aligns depends on an external magnetic field and on various anisotropy terms. One anisotropy term is determined by the geometrical shape of the sensor. For example, in GMR-sensors the shape anisotropy of the thin layered structure forces the magnetization into the plane of the ferromagnetic layer. Furthermore if the GMR has the shape of an elongated rectangular strip the shape anisotropy pulls the magnetization into the direction of the long side of the strip which is called the “easy axis”. If external magnetic fields with components in the plane of the GMR layer (in the following called “in-plane-fields”) and perpendicular to the long side of the GMR-strip are applied, then the magnetization, as a result, is rotated out of the easy axis. Thus, the sensor is sensitive to magnetic in-plane field components perpendicular to the easy axis.

In-plane field components parallel to the easy axis may cause adverse effects if they change from positive to negative magnetization values or vice versa. In this case the magnetization vector flips, i.e., the projection of the magnetization vector onto the easy axis changes its orientation. This flipping of the magnetization (occurring a short time lag after a corresponding zero crossing in the relevant magnetic field component) entails a discontinuity (e.g., a sudden change) in the macroscopic resistance of the magneto-resistive sensor which deteriorates position measurement.

This adverse effect may occur in measurement systems using currently used encoder wheels. Thus, there is a general need for an improved encoder wheel which is designed such that flipping of the magnetization in the sensor is prevented.

### SUMMARY OF THE INVENTION

A magnetic encoder element for use in a position measurement system including a magnetic field sensor for measuring position along a first direction is disclosed as one example of the invention. Further other examples of the invention are concerned with a sensor arrangement for non-contact position and/or speed measurement of a moving magnetic encoder element along a first direction.

Accordingly a magnetic encoder element for use in a position measurement system includes a magnetic field sensor for measuring position along a first direction. The encoder element includes at least one first track that includes a material providing a magnetic pattern along the first direction, the magnetic pattern being formed by a remanent magnetization vector that has a variable magnitude dependent on a position along the first direction. The gradient of the remanent magnetization vector is such that a resulting magnetic field in a corridor above the first track and at a predefined distance above the plane includes a field component perpendicular to the first direction that does not change its sign along the first direction.

### BRIEF DESCRIPTION OF THE DRAWINGS

The invention can be better understood with reference to the following drawings and description. The components in the figures are not necessarily to scale, instead emphasis being placed upon illustrating the principles of the invention. Moreover, in the figures, like reference numerals designate corresponding parts. In the drawings:

FIG. 1 illustrates the general measurement set-up including a magnetic encoder wheel and a magneto-resistive (MR) sensor for angular position measurement;

FIG. 2, that includes FIGS. 2a and 2b, illustrates the undesired effect of magnetization flip (reversion) in a thin MR layer due to an alternating magnetic field in a lateral direction perpendicular to the sensitive axis (x-axis) of the MR layer;

FIG. 3 illustrates the effect of a sudden change of MR sensor resistance due to a zero-crossing in the relevant magnetic field component;

FIG. 4 illustrates by means of a diagram the waveforms of the magnetic field depending from the position along the direction of motion for different lateral offset positions of the MR sensor

FIG. 5, that includes FIGS. 5a-5e, illustrates a magnetic pattern of an encoder element according to one example of the invention;

FIG. 6, that includes FIGS. 6a-6c, illustrates another example of an encoder element design;

FIG. 7, that includes FIGS. 7a-7c, illustrates a magnetic pattern of an encoder element according to another example of the invention;

FIG. 8, that includes FIGS. 8a-8c, illustrates a magnetic pattern of an encoder element according to a further example of the invention; and

FIG. 9, that includes FIGS. 9a-9d, illustrates an enhanced version of the example of FIG. 8.

### DETAILED DESCRIPTION OF ILLUSTRATIVE EMBODIMENTS

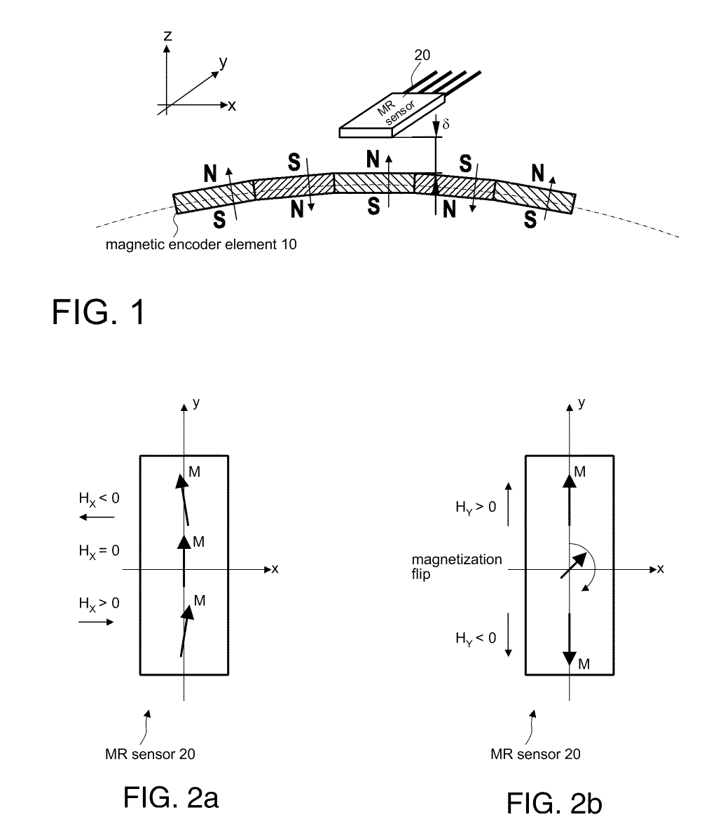

FIG. 1 illustrates a general measurement set-up for measuring angular position, speed or acceleration with a magneto-resistive magnetic field sensor and a magnetic encoder element 10 which in the current example is a magnetic encoder wheel. However, similar set-ups can be employed for measuring linear position, speed or acceleration. In such cases linear encoder elements are used, for example, magnetic encoder bars or the like. The MR sensor element 20 is usually arranged in a predefined distance from the encoder element 20 leaving an air gap 6 in between. Note that the true air gap is the distance from the surface of the encoder element 10 and the sensitive layer within the sensor chip. The distance sketched in FIG. 1 is the “apparent” air gap which is just an approximation of the true air gap.

The magnetic encoder wheel 10 includes a track that includes magnetized material providing a magnetic pattern. The magnetic pattern is usually binary. That is, it includes adjoining segments that are magnetized in alternating directions, wherein the remanent magnetization vector points towards the sensor in a direction (z-direction) perpendicular to the direction of the movement of the encoder element (x-direction) or antiparallel thereto. Thus an alternating magnetic pattern is provided.

The alternating magnetized segments are usually implemented by plastic-bonded permanent magnets. Thereby a plastic strip which comprises a magnetically hard material (e.g., ferrite powder with a remanent magnetization of 120 kA/m, or a remanence of 150 mT) is segment-wise magnetized in alternating and opposing directions yielding a structure as, for example, illustrated as encoder element 10 in FIG. 1. The magnetized plastic strip may be attached to a steel wheel which is mounted on a shaft (not shown) whose angular position or speed is to be measured.

To simplify the further discussion a cartesian coordinate system is defined. One should bear in mind that this definition is chosen rather arbitrarily but it helps to define relative positions of the elements shown in FIGS. 1 and 2 as well as the direction of the resulting magnetization and magnetic fields.

As mentioned above, the direction of motion shall be the x-direction. That is, the encoder element moves in the x-direction which is, in the case of an encoder wheel, a circumferential direction. The magnetization vectors present in the respective segments of the encoder wheel 10 point parallel or antiparallel to the z-direction, that is, the direction perpendicular to the plane where the plastic-bonded permanent magnets are located in. The z-direction is in the case on an encoder wheel a radial direction. Finally the lateral direction perpendicular to the x-direction and the z-direction is the y-direction and, in case of an encoder wheel an axial direction.

Assuming a remanent magnetization M={0, 0, M_{z}} of the permanent magnets only in the z-direction a three dimensional magnetic field H={H_{X}, H_{Y}, H_{Z}} can be observed at a position z=δ(air gap) above the surface of the encoder element 10, wherein in a symmetry plane of the encoder element 10 (the x-z-plane) the y-component H_{Y} of the magnetic field is ideally zero whereas the x-component H_{X} varies in an approximately sinusoidal manner as the encoder wheel 10 moves in the x-direction (see diagram of FIG. 4). The MR sensor is positioned such that its sensitive direction lies in the x-direction so as to measure the sinusoidal x-component H_{X} of the magnetic field resulting from the z-directed remanent magnetization of the encoder wheel 10. However, this has to be regarded as an example, the sensor 20 may also be placed in other positions relatively to the encoder wheel 10 if the remanent magnetization of the encoder wheel is oriented appropriately.

FIG. 2 illustrates in an exemplary manner the sensitive part of a MR sensor. Although many types of MR sensors are known (GMR: giant magneto-resistance, AMR: anisotropic magneto-resistance, TMR: tunnel magneto-resistance, CMR: colossal magneto-resistance, XMR: collective term for GMR, AMR, TMR, CMR, etc.) the problem described below is common to all types of MR sensors (i.e., XMR sensors).

XMR sensors are thin film sensors and include a plurality of (e.g., rectangular with a high aspect ratio in the case of a GMR sensor) ferromagnetic thin layers (“strips”) wherein the magnetization vector can rotate freely. The direction in which the magnetization aligns depends on an external magnetic field and on various anisotropy terms. One anisotropy term is determined by the geometrical shape of the sensor. For example, in GMR-sensors the shape anisotropy of the thin layered structure forces the magnetization into the plane of the ferromagnetic layer. Furthermore, if a XMR layer has the shape of an, for example, elongated rectangular strip (as in the case of a GMR sensors) the shape anisotropy pulls the magnetization into the direction of the long side of the strip which is called the “easy axis”. If external magnetic fields with components in the plane of the XMR (in the following called “in-plane-fields”) and perpendicular to the long side of the GMR strip are applied, then the magnetization, as a result, is rotated out of the easy axis which results in a change of ohmic resistance of the strip. Thus, the sensor is sensitive to magnetic in-plane field components (field components H_{X}) perpendicular to the easy axis (which lies in the y-direction). This effect is illustrated in FIG. 2a.

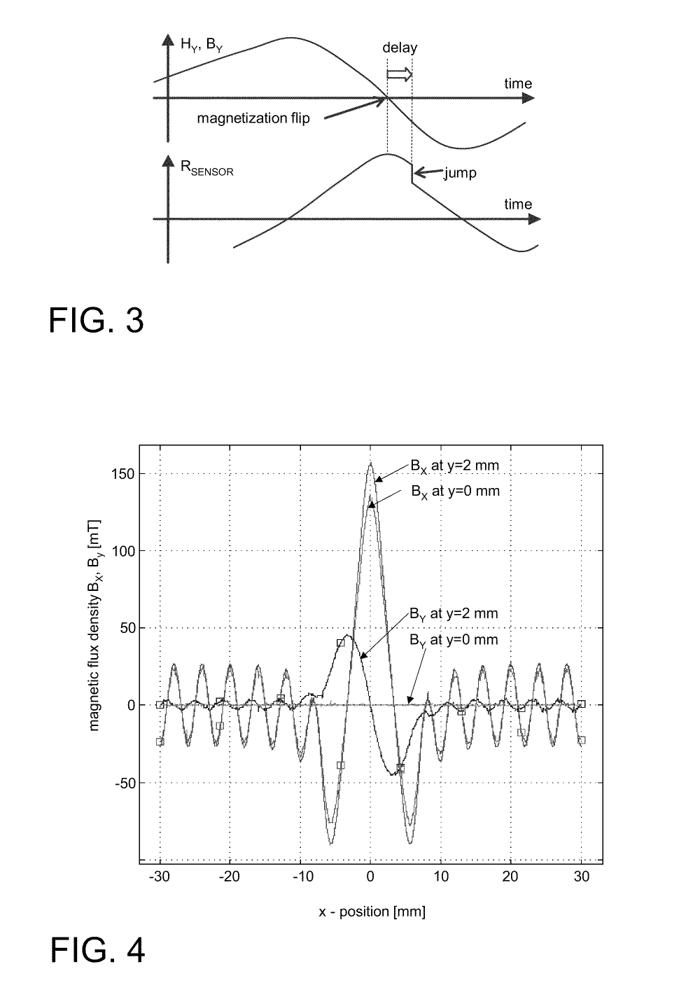

In-plane field components parallel to the easy axis (field component H_{Y}) may cause adverse effects if they change from positive to negative magnetization values or vice versa. In this case the magnetization vector flips, i.e., the projection of the magnetization vector onto the easy axis changes its orientation. This flip of the magnetization entails a discontinuity (e.g., a sudden change) in the macroscopic resistance R_{SENSOR} of the magneto-resistive sensor 20 which deteriorates position measurement. The flip of the magnetization is illustrated in FIG. 2b. The discontinuity in the sensor resistance R_{SENSOR} due to a zero-crossing of the magnetic field H_{Y} is illustrated in FIG. 3. It should be noted that for an undesired magnetization flip it is sufficient that the y-component of the magnetization vector changes from a positive to a negative value (or vice versa). A complete reversion of the magnetization vector is not necessary for observing the undesired discontinuity in the sensor resistance. Further, the field components H_{X} and H_{Y} are in quadrature when the encoder moves in the x-direction which results in a rotating in-plane magnetic field vector H={H_{X}, H_{Y}} which causes a continuous flipping of the magnetization in the thin magnetic layer of the MR sensor.

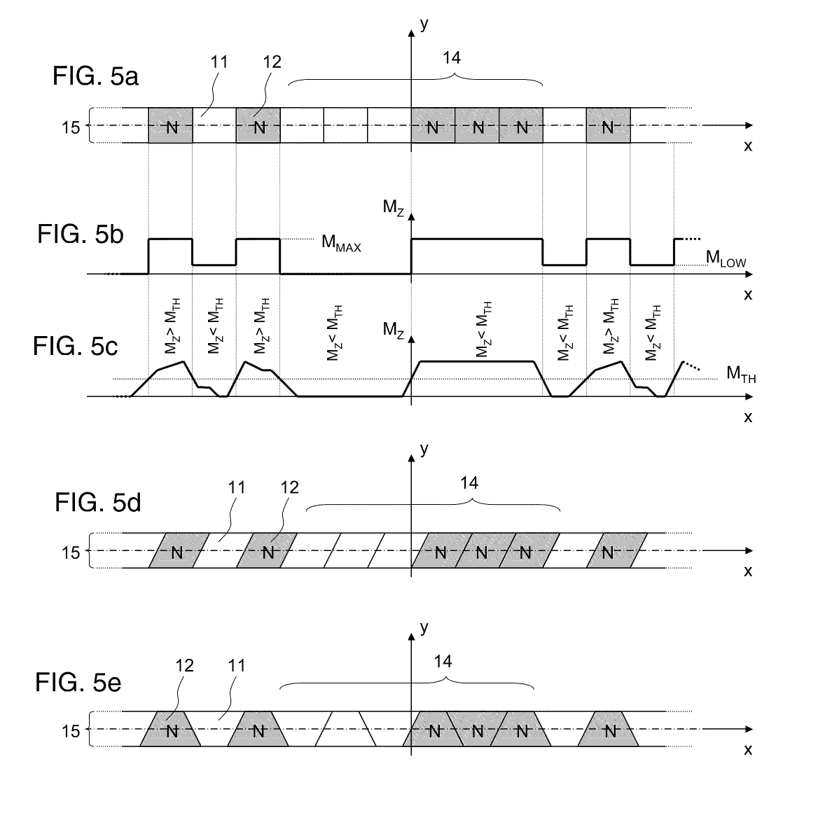

As mentioned above, in an ideal symmetric measurement set-up where the MR sensor is arranged in a plane of symmetry of the encoder element 10 (x-z-plane) the y-component of the external magnetic field generated by the permanent magnets of the encoder element 10 should be zero as illustrated in the diagram of FIG. 4. However, if the sensor element is located off the plane of symmetry at a position y≠0 (which likely is the case due to assembly tolerances) the lateral magnetic field component H_{Y} also varies in an alternating sinusoidal manner (see FIG. 4). When a zero-crossing of the magnetic field component H_{Y} occurs a magnetization flip is likely to occur (see FIG. 2b). This problem is further tightened by a so-called index zone (see also FIGS. 5 to 9, index zone 14) present in most encoder elements used in practice. Within the index zone the magnetized segments are broader than in the rest of the encoder element 10 in order to get a zero reference. The amplitude of the lateral magnetic field component H_{Y} is even larger within this index zone that makes a zero-crossing even more likely. If a magnetization flip occurs when the index zone of the encoder element 10 passes the MR sensor then the zero reference may be detected improperly rendering the following measurements corrupt. FIG. 4 shows how the index zone is “seen” by the MR sensor. The peak in the middle is indicative of the index zone. Please note, that the magnetic flux density B is used in the diagram of FIG. 4 instead of the magnetic field strength H. However, this leads only to a scaling of the ordinate axis of the diagram since B=μ₀H (μ₀ is the vacuum permeability).

In order to avoid the undesired magnetization flip the encoder element 10 should be designed such that the magnetic field H_{Y} in a lateral direction (y-direction) perpendicular to the direction of motion (x-direction) is always positive or always negative and does not change the sign. That is, the gradient of the remanent magnetization provided by the encoder element 10 when moving is such that a resulting magnetic field in the sensitive part of the field sensor comprises a field component perpendicular to the direction of motion that does not change its sign along the first direction.

To overcome the above-described problem, the classic magnetic north-south-pattern (see FIG. 1) may be modified as illustrated in FIG. 5 according to one example of the present invention. In FIG. 5a (as well as in the following figures) a magnetic encoder element having one track is depicted in a top view (i.e., as seen when looking against the z-direction). The position on the x-axis represents the displacement of the encoder element (e.g., either measured in millimeter or in degrees). FIG. 5b illustrates one example of the remanent magnetization vector M={0, 0, M_{Z}(x)} that represents the magnetization of the magnetic pattern along the direction of motion (x-direction). In this example, the magnetization M_{Z}(x) is only directed in the z-direction and is a function of the position. Shortly summarized, the encoder element of FIG. 5 comprises a first track 15 including a material providing a magnetic pattern along the first direction. The magnetic pattern is thereby formed by a remanent magnetization vector of the material, whereby the remanent magnetization vector has a variable magnitude dependent on a position along the first direction (i.e., the direction of motion, x-direction) and points essentially in one direction (e.g., the z-direction) and does not change its orientation along the first direction. In essence, this means that the sensor “sees” either only north poles or only south poles on the magnetic pattern of the first track 15, wherein the strength of the remanent magnetization M_{Z} varies along the x-direction so as to modulate the MR sensor output signal.

In order to get a large modulation of the sensor output when moving the encoder element, the magnetic pattern of the first track 15 may comprise a plurality of consecutive first and second segments 11, 12 along the first direction, wherein the remanent magnetization M_{Z} is low (denoted by magnetization M_{LOW} in FIG. 5b) or essentially zero in the first segments 11 and has a high (positive or negative) magnitude (denoted by magnetization M_{MAX} in FIG. 5b) in the second segments 12. The first and the second segments adjoin each other wherein a first segment follows a second segment, etc. Only in the index zone 14 two or more (three in the example of FIG. 5) first segments follow an equal number of second segments to provide a zero reference. Per definition, the x-coordinate is zero in the middle of the index zone. The length L of the first and second segments may be equal. In case of an encoder wheel one segment typically covers the circumference over 3° (π/60 rad). In the present example the remanent magnetization vectors should be oriented parallel to the z-direction, i.e., perpendicular to the plane wherein the first track 15 and thus the first and second segments 11, 12 are located in. A reason for the mentioned choice of the direction of the magnetization is given later in the text below.

More general, the first and second segments 11, 12 can be distinguished by defining a threshold level M_{TH} for the remanent magnetization. Accordingly, in the first segments 11 the remanent magnetization is below the threshold M_{TH} (i.e., M_{Z}<M_{TH}) and in the second segments 12 the remanent magnetization is above the threshold M_{TH} (i.e., M_{Z}>M_{TH}). This situation is illustrated in FIG. 5c. Just to give an example, the threshold could be set to μ₀M_{TH}=50 mT (millitesla). In the example of FIG. 5b the magnetization (scaled with the vacuum permeability μ₀) is approximately 10 mT in the first segments 11 and up to μ₀M_{MAX}≈150 mT in the second segments. The essential measure is the difference in remanent magnetization levels in the first and second segments 11, 12; the larger the difference in magnetization, the larger the dynamics at the sensor output. However it may be useful to set the magnetization in the first segments to about 10 to 30 per cent of the magnetization in the second segments (instead of zero) in order to achieve a more homogenous magnetic field. In view of FIG. 5b this relation could be written as M_{LOW}≈(0.1 . . . 0.3)·M_{MAX}. The segments may be manufactured by magnetizing the first and second segments to a high remanent magnetization level and then selectively demagnetizing the first segments. Since it is difficult to demagnetize them to exactly zero it may be useful to choose a target value slightly larger than zero (e.g., 10 percent of the maximum magnetization as mentioned above), so that despite the inevitable production tolerances, a change of sign (i.e., orientation) of the magnetization is avoided under all circumstances. It should be noted that the above applies to all examples of the invention and M_{LOW} needs not necessarily be zero in the first segments but could be set to any low value (compared to the magnetization value in the second segments) that yields a sufficient dynamics at the sensor output.

FIGS. 5d and 5e illustrate slight modifications of the magnetic pattern of FIG. 5a where the first and second segments 11, 12 essentially have a rectangular shape when depicted in a top view. As shown in FIG. 5d and FIG. 5e the first and second segments 11, 12 could also have the shape of a rhomboid or a trapezoid. However, the actual shape could still vary dependent on the tool the magnetic segments are produced with. The dimensions of the first and the second segments do not need to have the same dimensions (length L) in the direction (x-direction) of motion and (width W) in the lateral direction (y-direction). The above-described modifications also apply to the examples described further below with respect to the following figures.

With an encoder element, particularly an encoder wheel, having a magnetic pattern as illustrated in FIG. 5, a magnetization flip in the MR layer of the sensor may be prevented, especially if the sensitive MR sensor element (e.g., the GMR strips) is positioned with a small offset from the plane of symmetry (x-z-plane) extending along the direction of motion and perpendicular to the plane defined by the first track 15 (x-y-plane). The actual offset value can vary from 0.1 mm to a few millimeters (e.g., 3 mm) dependent on the actual dimensions of the total measurement system. Note that the position of the MR sensor 20 is defined to be the position of the centroid of the sensitive magneto-resistive layer within the sensor chip.

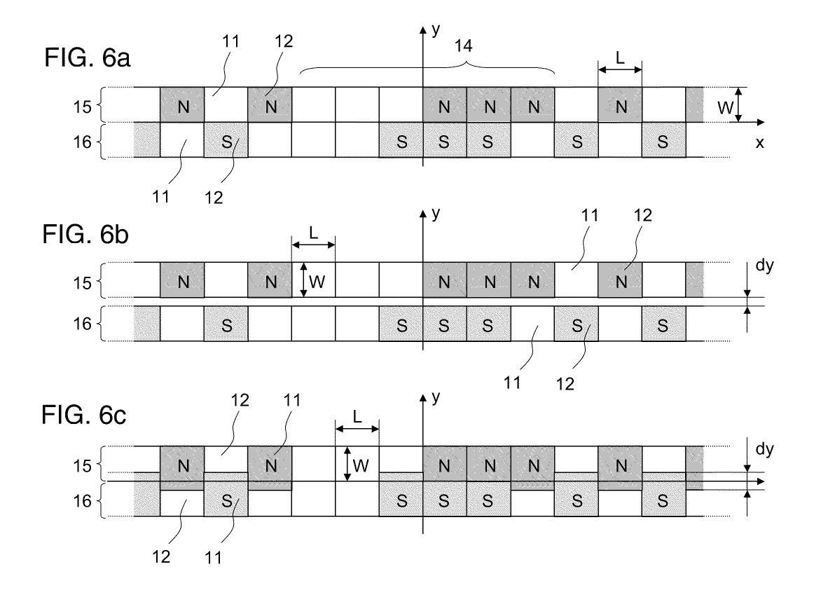

FIG. 6 illustrates another example of an encoder element design. Accordingly, additionally to the first track 15 illustrated in FIG. 5, the present example comprises a second track 16 having a material that provides a magnetic pattern along the first direction. This magnetic pattern of the second track 16 is also formed by a remanent magnetization vector having a variable magnitude dependent on a position along the first direction. However, the remanent magnetization vector of the first track and the remanent magnetization vector of the second track are essentially oriented anti-parallel and do not change their orientation along the first direction. Further the magnetic pattern of the first and the second track are shifted relatively to each other with respect to the first direction. This shift should not be too small. It equals, for example, the length L of one segment. However deviations from this ideal value are allowable and thus the shift can be in the range from L/2 to 3L/2. If the relative shift is too small (or too high) a first segments 11 of the first track with low (or zero) magnetization and a first segment 11 of the second track are located almost side by side that results in a low lateral magnetic field H_{Y} in the MR sensor layer; a situation which is sought to be avoided.

As illustrated in FIG. 5a the two tracks may be arranged alongside to each other and directly adjoin each other. Thus the magnetic patterns of the two tracks 15 and 16 can be realized as plastic-bonded magnets on one single plastic strip carrying both tracks. This situation which is illustrated in FIG. 6a is also metaphorically called “zip-pattern”.

As already discussed with respect to FIG. 5 the magnetic pattern of the second track 16 may also comprise first and second segments 11, 12 along the first direction, wherein the remanent magnetization M_{Z} is low or essentially zero in the first segments 11 and has a high magnitude in the second segments 12 (however inversely oriented as in the first track 15). Further, the second track 16 is designed very similar to the first track 15 so that the above description with reference to FIG. 5 is also applicable to the present example as far as possible.

As illustrated in FIG. 6b the two tracks 15 and 16 do not necessarily have to adjoin each other but can also be spaced apart from each other by a small offset dy. However, the tracks stay parallel to each other on the encoder element. The maximum allowable offset dy usually depends on various parameters, particularly on the dimensions of the total measurement system. Particularly the offset dy should stay smaller than a width W of the tracks 15, 16. FIG. 6c illustrates the case where the south- (S-)magnetized area of a second segment 12 of the second track 16 extends into a first segment 11 of the first track and vice versa. A partial overlap dy being a fraction of the width W of a segment is not a problem as long as the overlap dy is small compared to the width W. For example, the overlap dy should stay smaller than half of the width W of a segment.

Using a magnetic encoder element as illustrated in FIG. 6 the sensitive part of a MR sensor should be within a range of −W₁₅/2<y<W₁₆/2 (if we assume that track 15 has width W₁₅ and track 16 has width W₁₆ and that the origin y=0 is in the middle between the tracks). Note that the width of the tracks 15, 16 does not necessarily have to be equal.

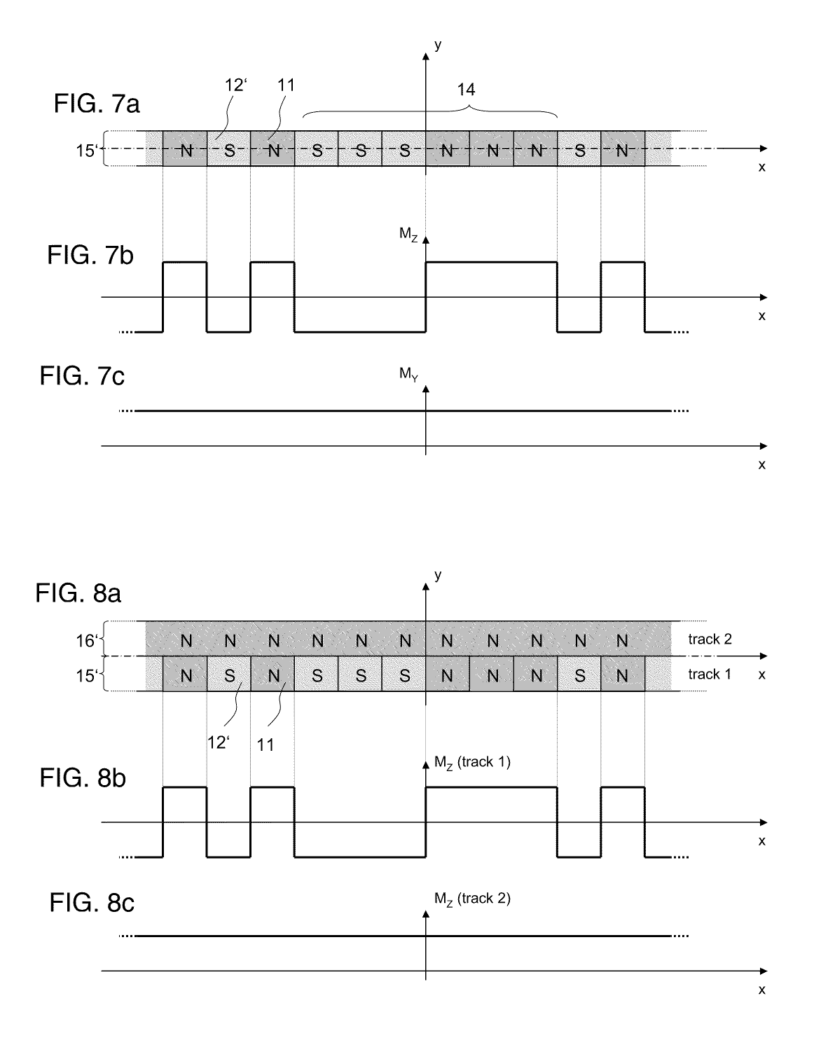

Another example of a magnetic encoder element 10 according to the present invention is illustrated in FIG. 7. This exemplary encoder element 10 illustrated in FIG. 7a comprises a first track 15′ comprising a material providing a magnetic pattern along the first direction (x-direction). The magnetic pattern is thereby formed by a first remanent magnetization vector M_{Z} (see FIG. 7b) that has a magnitude dependent on a position along the first direction and pointing essentially in one direction, particularly in the z-direction as in the previous examples described above. However, in the present example the first remanent magnetization vector M_{Z} may comprise positive and negative magnetization components M_{Z} and, as illustrated in FIG. 7b, a north pole segment 11 is followed by a south pole segment 12′.

Additionally to the first magnetization vector M_{Z}, the magnetic pattern is superposed by a second remanent magnetization vector M_{Y} that points essentially in a second direction being perpendicular to the direction of motion and does not change its orientation along the direction of motion. In the example of FIG. 7 the second remanent magnetization vector M_{Y} essentially lies in the x-y-plane. However, this is not necessarily the case. Dependent on the orientation of the MR sensor the second remanent magnetization vector M_{Y} may point perpendicular to the first remanent magnetization vector M_{Z} (as illustrated in FIG. 7b). Further, for example, the second remanent magnetization vector M_{Y} may be constant along the direction of motion (x-direction) as illustrated in FIG. 7c. In other words, a unipolar (i.e., not changing direction), particularly uniform, remanent magnetization M_{Y} in lateral direction (y-direction) superposes the alternating N-S-magnetization M_{Z} in z-direction.

As mentioned in the above paragraph, when using a different orientation of the sensor, the second remanent magnetization vector may point parallel to the first remanent magnetization vector thus directly superposing the first magnetization vector M_{Z}. In this case the second remanent magnetization vector should rather be denoted as M_{Z}′ instead of M_{Y} for the sake of consistency in the notation. If the absolute values of the first and the second remanent magnetization vectors are equal (with the first remanent magnetization vector, however, changing its orientation whereas the second does not), this superposition (i.e., M_{Z}+M_{Z}′) yields the same result as the unipolar magnetic pattern illustrated in FIG. 5.

Generally the second remanent magnetization vector should point in the direction of the easy axis of the XMR sensor used with the encoder element. In this general case the second remanent magnetization vector could rather be denoted as M_{e.a.} (with e.a. standing for “easy axis”) instead of M_{Y} or M_{Z}′ for the sake of consistency in the notation. The easy axis lies in the x-y-plane in the example of FIG. 7. However, the easy axis could point in any direction and dependent only on the orientation of the MR-sensor. In many applications the easy axis is equal to the y-axis (as it is the case in the example of FIG. 7b) or the z-axis.

A MR sensor used with an encoder element 10 as illustrated in FIG. 7 may be placed in or close to plane of symmetry (x-z-plane) above the first track 15 without the danger of magnetization flip in the magneto-sensitive MR layer of the sensor 20.

According to a further example (see FIG. 8) of the invention the superposition of the alternating N-S magnetization M_{Z} in z-direction with a unipolar magnetization M_{Y} in lateral direction can be replaced by a second track 16′ having a unipolar magnetization M_{Z} parallel to the magnetization of the first track 15′. Accordingly the first track 15′ of the encoder element 10 comprises a material that provides a magnetic pattern along the first direction. The magnetic pattern is formed by a remanent magnetization vector M_{Z} which has a variable magnitude dependent on a position along the direction of motion (x-direction, see FIG. 8b) and which points essentially in one direction (however changing orientation), particularly parallel to the z direction. The encoder element 10 further comprises a second track 16′ arranged alongside the first track and comprising a material providing a magnetic pattern along the first direction. The pattern is formed by a remanent magnetization vector oriented in the same direction as the remanent magnetization vector of the first track but not changing its orientation along the first direction. In particular, the remanent magnetization M_{Z} in the second track 16′ is uniform along the direction of motion (x-direction, see FIG. 8c). Thus the segments with a remanent N-magnetization form a comb-like structure as can be seen in FIG. 7a. Of course, the orientation of the remanent magnetization can be changed in both tracks thus inverting all magnetic field components without changing anything else.

The current example can also be seen as a decomposition of the magnetization of the magnetic pattern of FIG. 5 into two magnetic patterns placed on two parallel tracks. A theoretical superposition of the remanent magnetization of the first track 15′ and the second track 16′ may yield the magnetic pattern illustrated in FIG. 5. Consequently, one can conclude that the (theoretic) superposition, i.e., the vector sum, of the remanent magnetization vector of the first track 15′ and the remanent magnetization vector of the second track 16′ should, for all possible positions x along the x-direction, not revert its orientation. That is, the z-component of the sum should be either always be positive or always be negative.

The magnetic pattern of the first track comprises first and second segments 11, 12′ along the x-direction, whereby the orientation of the first remanent magnetization vector M_{Z} is anti-parallel in the first and the second segments 11, 12′. That is, the magnetization in z-direction changes its sign along the direction of motion (x-direction).

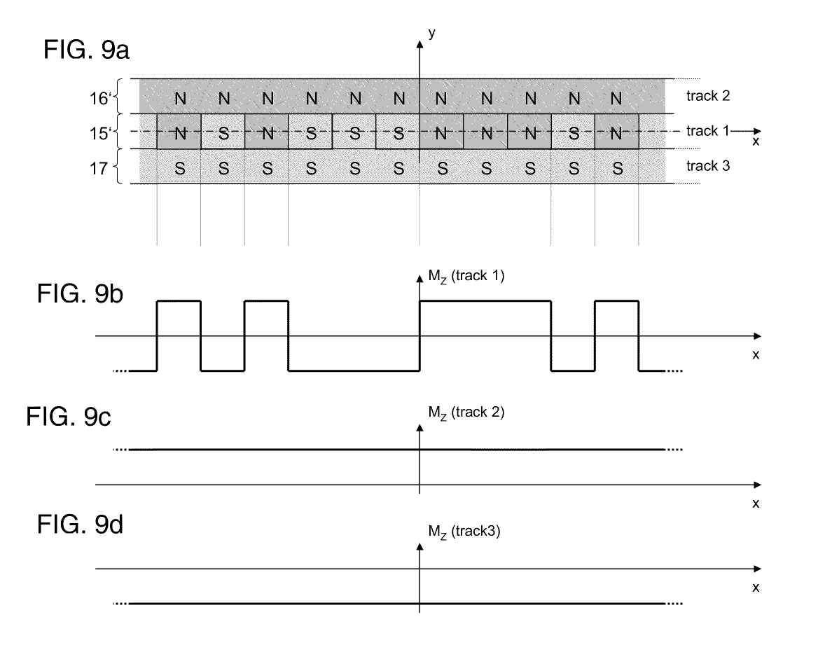

FIG. 9 illustrates, as another example of the present invention, another magnetic encoder element 10 similar to the encoder element 10 of FIG. 8. Additionally to the example of FIG. 8 the encoder wheel may comprise a third track 17 arranged alongside the first track 15′ such that the first track 15′ is enclosed by the second 16′ and the third track 17. Further, the third track 17 comprises a material providing a magnetic pattern along the direction of motion (x-direction, whereby the pattern is formed by a remanent magnetization vector oriented anti-parallel to the remanent magnetization vector of the second track, but not changing its orientation along the first direction. Thus the segments with a remanent S-magnetization form a second comb-like structure which interleaves with the comb-like structure made up of N-magnetization as can be seen in FIG. 9a. In particular, the magnetization M_{Z} in the second track 16′ and in the third track 17 may be uniform along the direction of motion but oppositionally oriented, i.e., the second track 16′ may be uniformly N-magnetized, whereas the third track 17 may be S-magnetized and the first track 15′ in between is alternately magnetized N and S.

The magnetization of the permanent magnets distributed along the direction of motion, e.g., along the perimeter of an encoder wheel 10, is usually mainly magnetized in the z-direction (i.e., in a radial direction in case of an encoder wheel and in a direction perpendicular to a main surface of a linear encoder element which carries the magnetic patterns). This has been described above with respect to all examples illustrated in FIGS. 5 to 9 except the example of FIG. 7 where the magnetic pattern is additionally magnetized in a lateral direction. The magnetic encoder element 10, be it an encoder wheel or a linear encoder, usually includes a steel back (e.g., a steel rim or a steel plate) not only for the purpose of mechanic stability. The steel back usually is ferromagnetic, magnetically soft and has a high permeability. As a consequence the steel back forces the magnetic flux lines to pass the surface of the steel back perpendicular to the surface which effectively, for symmetry reasons, doubles the volume of the permanent magnets attached to the steel back. Therefore, the remanent magnetization of the permanent magnets is usually chosen to be oriented perpendicular to the surface of the steel back. In practice, this means that the plastic-strip including the plastic-bonded permanent magnets is magnetized perpendicular to the main surface of the plastic strip. In the example of FIG. 7 an additional in-plane magnetization is provided in a lateral direction.

The examples described above relate to a magnetic encoder element for use in a position measurement system. Further examples of the invention cover a sensor arrangement for non-contact position and/or speed measurement of a moving encoder element along a first direction, in which the above described encoders can be used. The principal set-up of such an arrangement is illustrated in FIG. 1.

Although the present invention and its advantages have been described in detail, it should be understood that various changes, substitutions, and alterations can be made herein without departing from the spirit and scope of the invention as defined by the appended claims. For example, it will be readily understood by those skilled in the art that the magnetizations and their orientation may be altered while remaining within the scope of the present invention.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A magnetic encoder element for use in a position measurement system including a magnetic field sensor for measuring position along a first direction, the encoder element comprising:
a first track comprising a material providing a magnetic pattern along the first direction, the magnetic pattern being formed by a remanent magnetization vector that has a variable magnitude dependent on a position along the first direction,
wherein the remanent magnetization vector points essentially in one direction and does not change its orientation along the first direction.

2. The magnetic encoder element of claim 1,
wherein the magnetic pattern of the first track comprises a plurality of consecutive first and second segments along the first direction,
an absolute value of the remanent magnetization vector of the first track being essentially below a magnetization threshold within the first segments and above a magnetization threshold within the second segments.

3. The magnetic encoder element of claim 2,
wherein a magnitude of the remanent magnetization vector is essentially zero within the first segments.

4. The magnetic encoder element of claim 2,
wherein the first and the second segments are arranged in a plane defined by the first direction and a second direction perpendicular to the first direction, and
wherein the remanent magnetization vector points in a third direction perpendicular to the plane.

5. The magnetic encoder element of claim 2,
wherein the first segments are tilted with respect to a line perpendicular to the first direction or have a varying width perpendicular to the first direction.

6. The magnetic encoder element of claim 1, wherein the magnetic encoder element has only a single track comprising the material providing the magnetic pattern.

7. The magnetic encoder element of claim 2, further comprising:
a second track comprising a material providing a magnetic pattern along the first direction, the magnetic pattern of the second track being formed by a remanent magnetization vector having a magnitude dependent on a position along the first direction,
wherein the remanent magnetization vector of the first track and the remanent magnetization vector of the second track are essentially oriented anti-parallel and do not change their orientation along the first direction, and
wherein the first track and the second track are arranged alongside to each other and the magnetic patterns of the first track and the second track are shifted relatively to each other in the first direction.

8. The magnetic encoder element of claim 7,
wherein the magnetic pattern of the second track comprises a plurality of consecutive first and second segments along the first direction,
an absolute value of the remanent magnetization vector of the second track being essentially below a magnetization threshold within the first segments and above the magnetization threshold within the second segments of the second track.

9. The magnetic encoder element of claim 7,
wherein the relative shift between the magnetic patterns of the first and the second tracks is such that a first segment in the first track is located vis-à-vis a second segment in the second track.

10. The magnetic encoder element of claim 7, wherein the relative shift between the magnetic patterns of the first track and the second track essentially equal a width of the first and the second segments along the first direction.

11. The magnetic encoder element of claim 8,
wherein the first and the second segments are arranged in a plane defined by the first direction and a second direction perpendicular to the first direction, and
wherein the remanent magnetization vector points in a third direction perpendicular to the plane.

12. The magnetic encoder element of claim 7, wherein the magnetic encoder element has only two tracks comprising the material providing the magnetic patterns.

13. The magnetic encoder element of claim 8,
wherein the first segments of the magnetic pattern of the first track partly extend into the second segments of the magnetic pattern of the second track,
wherein an overlap of the magnetic patterns of the first track and the second track is less than half of a width of the tracks perpendicular to the first direction.

14. The magnetic encoder element of claim 8,
wherein the first track and the second track are arranged side by side at a given distance, wherein a distance between the tracks is less than a width of the tracks perpendicular to the first direction.

15. The magnetic encoder element of claim 1, wherein the encoder element is a wheel, the first track being arranged around a circumference of the wheel or on a front of the wheel in a circumferential direction, thus the first direction being a circumferential direction.

16. The magnetic encoder element of claim 1,
wherein the material providing the magnetic pattern is a plastic strip of plastic-bonded permanent magnets attached to the encoder element along the first direction thus forming the first track.

17. A magnetic encoder element for use in a position measurement system including a magnetic field sensor, the encoder element comprising:
a first track comprising a material providing a magnetic pattern along a first direction, the magnetic pattern being formed by a first remanent magnetization vector having a varying magnitude and orientation dependent on a position along the first direction,
wherein the magnetic pattern is superposed by a second remanent magnetization vector that points essentially in a second direction being perpendicular to the first direction and not changing its orientation along the first direction.

18. The magnetic encoder element of claim 17,
wherein the magnetic pattern of the first track comprises first and second segments along the first direction,
the orientation of the first remanent magnetization vector being anti-parallel in the first and the second segments.

19. The magnetic encoder element of claim 17,
wherein the second remanent magnetization vector has essentially constant magnitude and orientation along the first direction.

20. A magnetic encoder element for use in a position measurement system including a magnetic field sensor for measuring position along a first direction, the encoder element comprising:
a first track comprising a material providing a magnetic pattern along the first direction, the magnetic pattern being formed by a remanent magnetization vector having a varying magnitude and orientation dependent on a position along the first direction, and
a second track arranged alongside the first track and comprising a material providing a magnetic pattern along the first direction, the pattern being formed by a remanent magnetization vector oriented in a same direction as the remanent magnetization vector of the first track but not changing its orientation along the first direction.

21. The magnetic encoder element of claim 20,
wherein the magnetic pattern of the first track comprises first and second segments along the first direction,
the orientation of the remanent magnetization vector is anti-parallel in the first and the second segments.

22. The magnetic encoder element of claim 20,
wherein the remanent magnetization vector in the second track has essentially constant magnitude and orientation along the first direction.

23. The magnetic encoder element of claim 20, further comprising:
a third track arranged alongside the first track such that the first track is enclosed by the second and the third track, the third track comprising a material providing a magnetic pattern along the first direction, the pattern being formed by a remanent magnetization vector oriented anti-parallel to the remanent magnetization vector of the second track and not changing its orientation along the first direction.

24. The magnetic encoder element of claim 23,
wherein the remanent magnetization vector in the third track has essentially constant magnitude and orientation along the first direction.

25. A magnetic encoder element for use in a position measurement system including a magnetic field sensor for measuring position along a first direction, the encoder element comprising:
at least one first track comprising a material providing a magnetic pattern along the first direction, the magnetic pattern being formed by a remanent magnetization vector that has a variable magnitude dependent on a position along the first direction,
where the magnetic pattern of the at least one first track comprises a plurality of consecutive first and second segments located in a plane along the first direction,
an absolute value of the remanent magnetization vector being essentially below a magnetization threshold within the first segments and above a magnetization threshold within the second segments,
wherein a gradient of the remanent magnetization vector is such that a resulting magnetic field in a corridor above the first track and at a predefined distance above the plane comprises a field component perpendicular to the first direction that does not change its sign along the first direction.

26. A sensor arrangement for non-contact position and/or speed measurement of a moving magnetic encoder element along a first direction, the arrangement comprising:
the magnetic encoder element with a first track comprising a material that provides a magnetic pattern along the first direction, the magnetic pattern being formed by a remanent magnetization vector that has a variable magnitude dependent on a position along the first direction;
a magnetic field sensor arranged adjacent to the magnetic encoder element leaving a predefined gap in between, whereby the sensor has a thin magnetic layer sensitive to magnetic field components in the first direction resulting from the magnetic pattern of the encoder element,
wherein a gradient of the remanent magnetization vector is such that, in the magnetic layer, a resulting magnetic field component in a second direction perpendicular to the first direction does not change its sign along the first direction.

27. The sensor arrangement of claim 26,
wherein the remanent magnetization vector forming the magnetic pattern of the first track points essentially in one direction and does not change its orientation along the first direction.

28. The sensor arrangement of claim 26,
wherein the encoder element comprises a second track comprising a material that provides a magnetic pattern along the first direction, the magnetic pattern of the second track being formed by a remanent magnetization vector having a magnitude dependent on a position along the first direction,
wherein the remanent magnetization vector of the first track and the remanent magnetization vector of the second track are essentially oriented anti-parallel and do not change their orientation along the first direction, and
wherein the first track and the second track are arranged alongside to each other and the magnetic patterns of the first track and the second track are shifted relatively to each other in the first direction.

29. The sensor arrangement of claim 26,
wherein the magnetic pattern of the first track is formed by a first remanent magnetization vector having a varying magnitude and orientation dependent on a position along the first direction, and
wherein the magnetic pattern of the first track is superposed by a second remanent magnetization vector that points essentially in a second direction that is perpendicular to the first direction and parallel to an easy axis of the thin magnetic layer and not changing its orientation along the first direction.

30. The sensor arrangement of claim 26,
wherein the magnetic pattern of the first track is formed by a first remanent magnetization vector having a varying magnitude and orientation dependent on a position along the first direction;
wherein the encoder element further comprises a second track arranged alongside the first track and comprising a material providing a magnetic pattern along the first direction, the pattern being formed by a remanent magnetization vector oriented in a same direction as the remanent magnetization vector of the first track but not changing its orientation along the first direction.

31. The sensor arrangement of claim 28,
wherein the encoder element further comprises a third track arranged alongside the first track such that the first track is enclosed by the second track and the third track, the third track comprising a material providing a magnetic pattern along the first direction, the pattern being formed by a remanent magnetization vector oriented anti-parallel to the remanent magnetization vector of the second track and not changing its orientation along the first direction.
